(19) United States
(12) Patent Application Publication
(10) Pub. No.: US 2007/0029383 A1
(43) Pub. Date: Feb. 8, 2007

(54) Multi-function imaging apparatus

(75) Inventor: Monty L. Francis, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/198,479

(22) Filed: Aug. 5, 2005

(51) Int. Cl. G06F 15/12; G06F 17/00

(52) U.S. Cl. 235/432; 235/375

(57) ABSTRACT

An imaging apparatus includes a printing mechanism configured to communicate with a controller for performing a printing operation. An embossing mechanism is configured to communicate with the controller for performing an embossing operation. A cutting mechanism is configured to communicate with the controller for performing a cutting operation. A memory card reader is communicatively coupled to the controller. The memory card reader reads a removable memory card to retrieve printing data, embossing data and cutting data from the removable memory card. The controller executes program instructions to control the printing mechanism, the embossing mechanism and the cutting mechanism in accordance with the printing data, the embossing data and the cutting data.

### BACKGROUND OF THE INVENTION

1. Field of the Invention.

The present invention relates to an imaging apparatus, and, more particularly, to an imaging apparatus configured to perform multiple functions.

2. Description of the Related Art.

An imaging apparatus is typically used to print on a sheet of media. In some craft projects, a user will print a picture on a sheet of media, and then manually manipulate the sheet into the desired form, such as for example, by embossing the sheet with a stamp, or cutting around the picture with scissors.

### SUMMARY OF THE INVENTION

The invention, in one exemplary embodiment, is directed to an imaging apparatus. The imaging apparatus includes a controller, and a printing mechanism configured to communicate with the controller for performing a printing operation. An embossing mechanism is configured to communicate with the controller for performing an embossing operation. A cutting mechanism is configured to communicate with the controller for performing a cutting operation. A memory card reader is communicatively coupled to the controller. The memory card reader is configured to read a removable memory card to retrieve printing data, embossing data and cutting data from the removable memory card. The memory card reader is configured to send the printing data, the embossing data, and the cutting data to the controller. The controller executes program instructions to control the printing mechanism, the embossing mechanism and the cutting mechanism in accordance with the printing data, the embossing data and the cutting data.

The invention, in another form thereof, is directed to a method for operating an imaging apparatus that processes a sheet of media having a front side and a back side. The method includes loading a removable memory card into a memory card reader; reading the memory card to retrieve embossing data; and controlling an embossing mechanism to perform an embossing operation in accordance with the embossing data.

The invention, in another form thereof, is directed to a method for operating an imaging apparatus that processes a sheet of media having a front side and a back side. The method includes loading a removable memory card into a memory card reader; reading the memory card to retrieve printing data, embossing data, and cutting data from the memory card; and controlling a printing mechanism, an embossing mechanism and a cutting mechanism in accordance with the printing data, the embossing data and the cutting data, respectively, to perform a printing operation, an embossing operation, and a cutting operation, respectively.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system, including an imaging apparatus embodying the present invention.

FIG. 2 is a diagrammatic depiction of the embossing mechanism of the imaging apparatus of FIG. 1.

FIG. 3 is a diagrammatic depiction of the cutting mechanism of the imaging apparatus of FIG. 1.

FIG. 4 is a diagrammatic depiction of an embodiment of the imaging apparatus of FIG. 1, which includes a reciprocating cartridge carrier.

FIG. 5 is one exemplary method of operating the imaging apparatus of FIG. 1.

FIG. 6 is another exemplary method of operating the imaging apparatus of FIG. 1.

FIG. 7 is another exemplary method of operating the imaging apparatus of FIG. 1.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

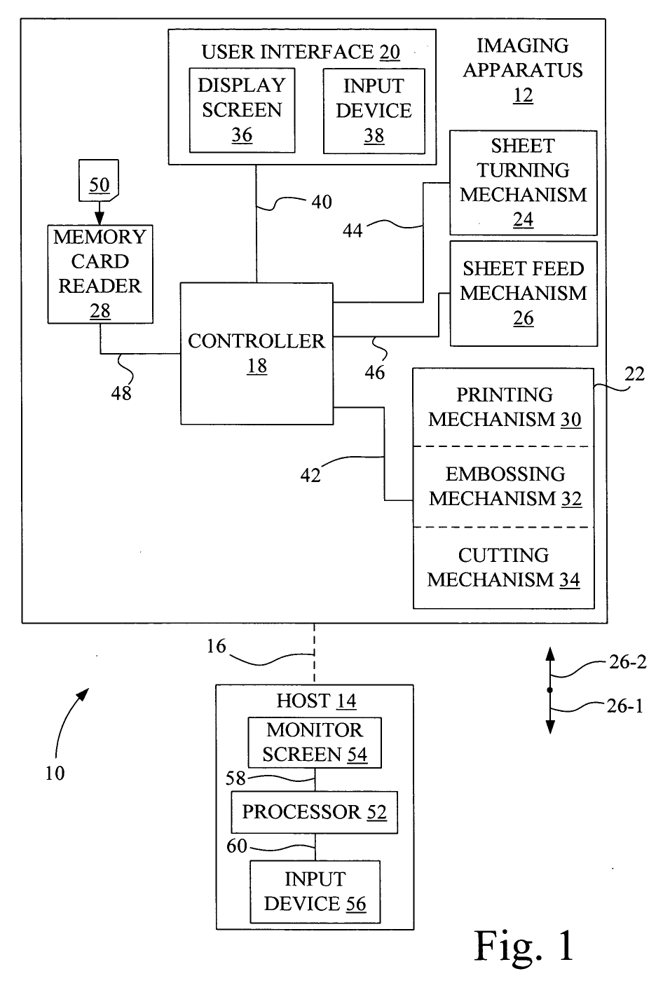

Referring now to the drawings and particularly to FIG. 1, there is shown a system 10 embodying the present invention. System 10 includes an imaging apparatus 12. In the present embodiment, imaging apparatus 12 is in the form of a multi-function imaging apparatus, and may operate as a standalone unit. Optionally, imaging apparatus 12 may be configured to be communicatively coupled to an external operator console, such as a host 14, via a communications link 16.

As used herein, the term “communications link” generally refers to structure that facilitates electronic communication between two components, and may operate using wired or wireless technology. Accordingly, communications links, such as communications link 16, may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

Imaging apparatus 12 includes a controller 18, a user interface 20, a media processing unit 22, a sheet turning mechanism 24, a sheet feed mechanism 26, and a memory card reader 28. Media processing unit 22 may include, for example, a printing mechanism 30 for performing a printing operation, an embossing mechanism 32 for performing an embossing operation, and a cutting mechanism 34 for performing a cutting operation. User interface 20 includes a display screen 36, or a video output to a television, and an input device 38, such as a keypad or a remote control, which may be used to view menu screens containing options available with respect to the various operations.

Controller 18 is communicatively coupled to user interface 20 via a communications link 40. Controller 18 is communicatively coupled to media processing unit 22 via a communications link 42. In turn, each of printing mechanism 30, embossing mechanism 32, and cutting mechanism 34 is configured to communicate with controller 18 via communications link 42. Controller 18 is communicatively coupled to sheet turning mechanism 24 via a communications link 44. Controller 18 is communicatively coupled to sheet feed mechanism 26 via a communications link 46. Controller 18 is communicatively coupled to memory card reader 28 via a communications link 48.

Media processing unit 22 may include a print engine, such as an ink jet print engine, into which printing mechanism 30 is incorporated, in which case printing mechanism 30 may include an ink jet printhead cartridge. As is known in the art, an ink jet printhead cartridge includes an ink supply reservoir and an ink jet printhead connected to the ink supply reservoir.

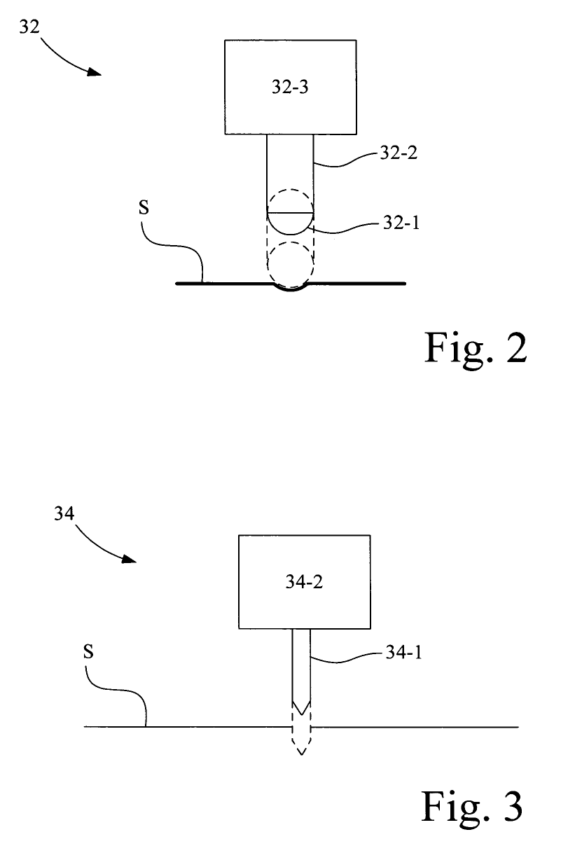

Embossing mechanism 32 is used in performing an embossing operation. Referring to FIG. 2, embossing mechanism 32 may include, for example, a roller ball 32-1 mounted to a holder 32-2, which is selectively brought into and out of engagement with the sheet of media S by an actuator 32-3, such that embossing mechanism 32 is selectively engagable with the sheet of media S, such as paper. Actuator 32-3 may be, for example, an electrical solenoid. Embossing mechanism 32 engages the sheet of media S and leaves an indented imprint on the surface of the sheet of media S that comes in contact with roller ball 32-1. The sheet of media S and embossing mechanism 32 are moved relative to one another to form an embossed design on the sheet of media S.

Cutting mechanism 34 is used in performing a cutting operation. Referring to FIG. 3, cutting mechanism 34 may include, for example, a cutting device 34-1 which is selectively brought into and out of engagement with the sheet of media S by an actuator 34-2, such that cutting mechanism 34 is selectively engagable with the sheet of media S. Actuator 34-2 may be, for example, an electrical solenoid. One example of cutting device 34-1, which can also be used for perforating, includes a reciprocating needle. Other known cutting devices include, for example, rotary cutters and knife cutters.

Sheet feed mechanism 26 includes a plurality of driven rollers, and associated backup rollers, for conveying the sheet of media S, such as paper, in either of a forward feed direction 26-1 or a reverse feed direction 26-2, as commanded by controller 18.

Sheet turning mechanism 24 may receive the sheet of media S from sheet feed mechanism 26. Sheet turning mechanism 24 is used, for example, to flip the sheet of media S from front side processing to back side processing, or vice versa. Sheet turning mechanism 24 may be, for example, in the form of a plurality of driven rollers, and associated backup rollers, arranged along a C-shaped path that receives the sheet of media S from sheet feed mechanism 26 and in turn conveys the sheet of media S back to sheet feed mechanism 26 with the opposite side of the sheet of media S now facing up. In one embodiment, for example, sheet turning mechanism 24 flips the sheet of media S prior to the embossing operation to facilitate embossing on the back side of the sheet of media S, e.g., the side of the sheet of media S opposite to the side that receives print.

Memory card reader 28 is a unit configured for receiving a standard removable memory card 50, such as for example, an SD memory card, etc. In accordance with the present invention, memory card 50 is used to store printing data, embossing data, and/or cutting data. As such, memory card 50 may store commercially available designs, or alternatively, may be programmed by a user with one or more designs, to be used for generating craft projects, greeting cards, etc. The contents of memory card 50 may be reviewed and/or modified via user interface 20, or host 14.

The printing data, embossing data, and/or cutting data may be stored, for example, in encoded, e.g., encrypted, form. Memory card reader 28 is configured to read removable memory card 50 to retrieve printing data, embossing data and/or cutting data from removable memory card 50. Also, memory card reader 28 is configured to send the retrieved printing data, embossing data, and/or cutting data to controller 18 for decoding and/or other processing.

In some embodiments of imaging apparatus 12, controller 18 may include in its memory a software or firmware program including program instructions, which when executed function as a driver for printing mechanism 30, embossing mechanism 32 and/or cutting mechanism 34, and will be referred to herein as a driver program. The driver program, for example, may include a halftoning unit and a data formatter subroutine that processes printing data retrieved from removable memory card 50, wherein printing mechanism 30 is controlled in accordance with the printing data during a printing operation. Also, the driver program may include an embossing driver subroutine for processing embossing data retrieved from removable memory card 50, which may be in the form of numerical control data, and wherein embossing mechanism 32 is controlled in accordance with the embossing data during an embossing operation. Further, the driver program may include a cutting driver subroutine for processing cutting data retrieved from removable memory 50, which may be in the form of numerical control data, and wherein cutting mechanism 34 is controlled in accordance with the cutting data during a cutting operation. The driver program may be accessed, for example, by a software application, such as for example, a label making application, a card stock application, etc., that is executing on imaging apparatus 12.

During the processing of a sheet of media S, controller 18 executes program instructions to control printing mechanism 30, embossing mechanism 32 and cutting mechanism 34 in accordance with the printing data, the embossing data and the cutting data, respectively. Controller 18 also executes program instructions to control sheet feed mechanism 26 to feed the sheet of media S in forward feed direction 26-1 or in reverse feed direction 26-2.

For example, in one embodiment, controller 18 may execute program instructions to feed the sheet of media S in the forward feed direction 26-1 during a printing operation, feed the sheet of media S in the reverse feed direction 26-2 between the printing operation and the embossing operation, feed the sheet of media S in the forward feed direction 26-1 during the embossing operation, feed the sheet of media S in a reverse feed direction 26-2 between the embossing operation and the cutting operation, and feed the sheet of media S in the forward feed direction 26-1 during the cutting operation. Alternatively, the embossing and/or cutting operations may include a combination of forward and/or reverse feeds.

As another example, controller 18 may execute program instructions such that the printing operation is performed in accordance with the printing data with the sheet of media S being fed in the forward feed direction 26-1, the embossing operation is performed in accordance with the embossing data with the sheet of media S being fed in the reverse feed direction 26-2, and the cutting operation is performed in accordance with the cutting data with the sheet of media S being fed in the forward feed direction 26-1.

In embodiments including an external operator console, such as host 14, host 14 may be, for example, a personal computer including a processor 52, a monitor screen 54 and an input device (e.g., keyboard) 56, and further includes such devices as input/output (I/O) interfaces, memory, such as RAM, ROM, NVRAM, and a mass data storage device, such as a hard drive, CD-ROM and/or DVD units. Processor 52 is communicatively coupled to monitor screen 54 via communications link 58. Processor 52 is communicatively coupled to input device 56 via communications link 60. Further, processor 52 is communicatively coupled to controller 18 of imaging apparatus 12 via communication link 16. Host 14 may be used in a manner similar to that of user interface 20 of imaging apparatus 12.

During any of a printing operation, an embossing operation, or a cutting operation, host 14 may include in its memory all or a portion of the driver program described above as the driver for imaging apparatus 12. The driver program may be accessed, for example, by a software application, such as for example, a word processing application, label making application, a card stock application, etc., that is executing on host 14.

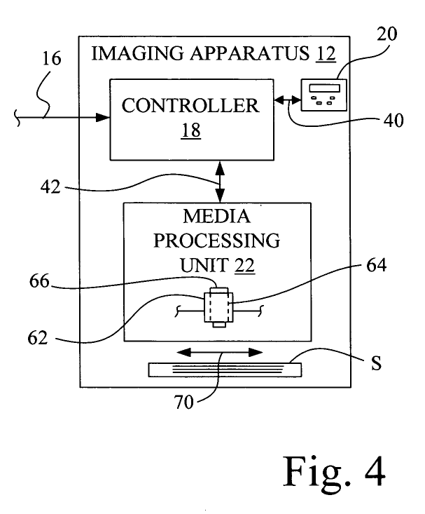

Referring to FIG. 4, in one embodiment media processing unit 22 may include a reciprocating cartridge carrier 62, of a type commonly used in ink jet printers. Reciprocating cartridge carrier 62 may be configured with one or more cartridge bays 64. Each cartridge bay 64 is configured for mounting at least one of a plurality of interchangeable cartridges 66. The plurality of interchangeable cartridges 66 may include, for example, a print cartridge containing printing mechanism 30 (e.g., in the form of an ink jet printhead cartridge), an embossing cartridge containing embossing mechanism 32, and a cutting cartridge including cutting mechanism 34. Alternatively, embossing mechanism 32 and cutting mechanism 34 may be accommodated by the same cartridge, with only one of embossing mechanism 32 and cutting mechanism 34 being installed in the cartridge at any one time.

Media processing unit 22 processes the sheet of media S, having a front side and a back side, under reciprocating cartridge carrier 62 for processing by printing mechanism 30, embossing mechanism 32 and/or cutting mechanism 34. The terms “front side” and “back side” may be arbitrary, as in the case of plain paper, or may be predefined, as in the case of coated paper, wherein the front side is considered to be the side intended to display a printed image. Reciprocating cartridge carrier 62 travels in a bi-directional scanning direction 70 over the sheet of media S, which is orthogonal to forward feed direction 26-1 and reverse feed direction 26-2 (see FIG. 1).

Controller 18 may further execute program instructions to prompt a user to select a particular cartridge of the plurality of interchangeable cartridges 66 to perform a next operation of the printing operation, the embossing operation and the cutting operation. For example, if the next operation is an embossing operation, the controller may cause user interface 20, or alternatively host 14, to display a message on display screen 36 and/or monitor screen 54 prompting the user to install the embossing cartridge prior to beginning the embossing operation.

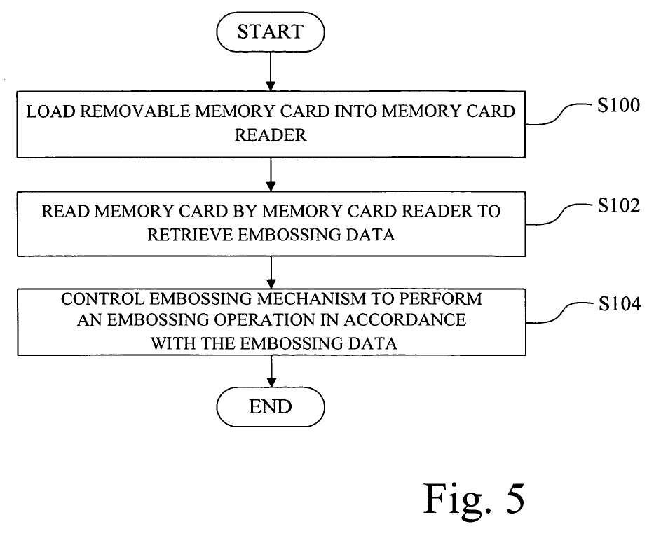

Exemplary methods of operating imaging apparatus 12 will now be described with further reference to FIGS. 5, 6, and 7.

In the method of FIG. 5, at step S100, removable memory card 50 is loaded into memory card reader 28.

At step S102, memory card 50 is read by memory card reader 28 to retrieve embossing data. Alternatively, or supplemental to the embossing data, printing data and/or cutting data also may be retrieved from memory card 50.

At step S104, embossing mechanism 32 is controlled to perform an embossing operation in accordance with the embossing data. The embossing operation may be performed, for example, by embossing the back side of the sheet of media S. In embodiments that include print data, printing mechanism 30 may be controlled to perform the printing operation, for example, prior to the embossing operation. In embodiments that include cutting data, cutting mechanism 34 may be controlled to perform the cutting operation, for example, following the embossing operation.

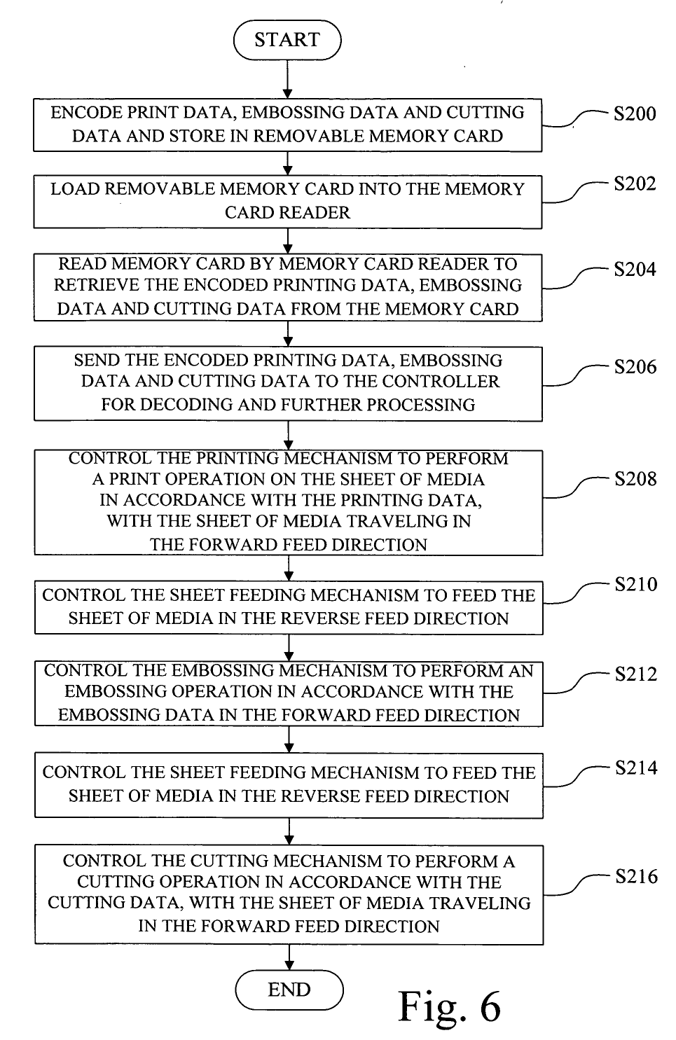

In the method of FIG. 6, at step S200, print data, embossing data and cutting data are encoded and stored in removable memory card 50.

At step S202, removable memory card 50 is loaded into memory card reader 28.

At step S204, memory card 50 is read by memory card reader 28 to retrieve the encoded printing data, embossing data and cutting data from memory card 50.

At step S206, memory card reader 28 sends the encoded printing data, embossing data and cutting data to controller 18 for decoding and further processing;

At step S208, printing mechanism 30 is controlled to perform a print operation on the sheet of media S in accordance with the printing data, with the sheet of media S traveling in the forward feed direction 26-1.

At step S210, sheet feeding mechanism 26 is controlled to feed the sheet of media S in the reverse feed direction 26-2. During step S210, the sheet of media S may be processed through sheet turning mechanism 24 to flip the sheet of media S prior to the embossing operation. Alternatively, if desired, a user may manually flip the sheet of media S.

At step S212, embossing mechanism 32 is controlled to perform an embossing operation in accordance with the embossing data in the forward feed direction 26-1.

At step S214, sheet feeding mechanism 26 is controlled to feed the sheet of media S in the reverse feed direction 26-2. During step S214, the sheet of media S may be processed through sheet turning mechanism 24 to flip the sheet of media S prior to the cutting operation, if desired. Alternatively, if desired, a user may manually flip the sheet of media S.

At step S216, cutting mechanism 34 is controlled to perform a cutting operation in accordance with the cutting data, with the sheet of media S traveling in the forward feed direction 26-1.

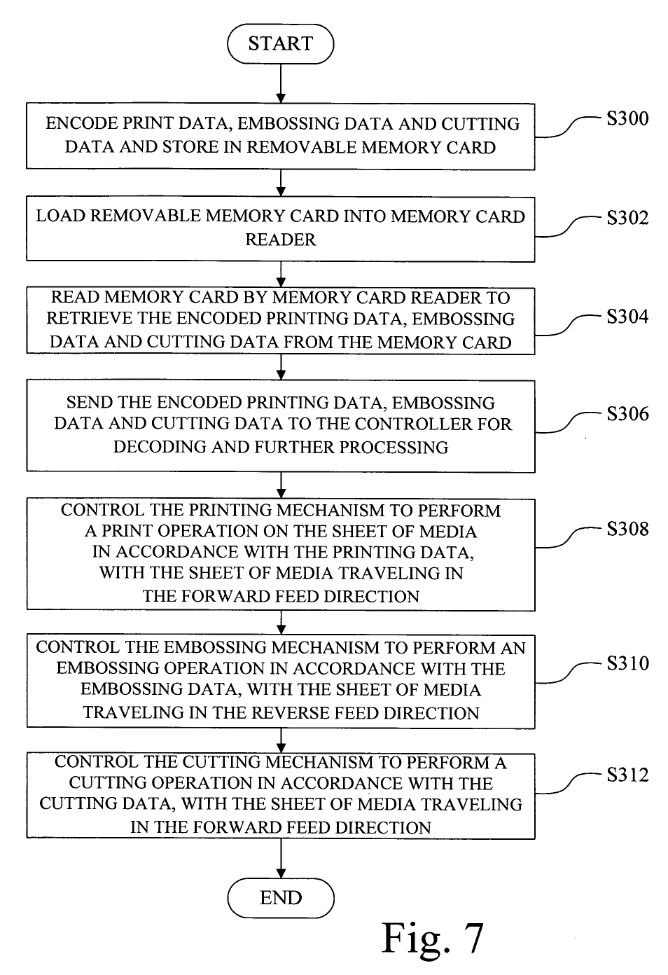

In the method of FIG. 7, at step S300, print data, embossing data and cutting data are encoded and stored in removable memory card 50.

At step S302, removable memory card 50 is loaded into memory card reader 28.

At step S304, memory card 50 is read by memory card reader 28 to retrieve the encoded printing data, embossing data and cutting data from said memory card.

At step S306, memory card reader 28 sends the encoded printing data, embossing data and cutting data to controller 18 for decoding and further processing;

At step S308, printing mechanism 30 is controlled to perform a print operation on the sheet of media S in accordance with the printing data, with the sheet of media S traveling in the forward feed direction 26-1.

At step S310, embossing mechanism 32 is controlled to perform an embossing operation in accordance with the embossing data, with the sheet of media traveling in the reverse feed direction 26-2. Prior to the embossing operation, if desired, the sheet of media S may be processed through sheet turning mechanism 24 to flip the sheet of media S. Alternatively, if desired, a user may manually flip the sheet of media S.

At step S312, cutting mechanism 34 is controlled to perform a cutting operation in accordance with the cutting data, with the sheet of media S traveling in the forward feed direction 26-1. Prior to the cutting operation, if desired, the sheet of media S may be processed through sheet turning mechanism 24 to flip the sheet of media S. Alternatively, if desired, a user may manually flip the sheet of media S.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus, comprising:
a controller;
a printing mechanism configured to communicate with said controller for performing a printing operation;
an embossing mechanism configured to communicate with said controller for performing an embossing operation;
a cutting mechanism configured to communicate with said controller for performing a cutting operation; and
a memory card reader communicatively coupled to said controller, said memory card reader configured to read a removable memory card to retrieve printing data, embossing data and cutting data from said removable memory card,
said memory card reader being configured to send said printing data, said embossing data, and said cutting data to said controller, said controller executing program instructions to control said printing mechanism, said embossing mechanism and said cutting mechanism in accordance with said printing data, said embossing data and said cutting data.

2. The imaging apparatus of claim 1, further comprising a sheet feed mechanism coupled to said controller, said controller executing program instructions to feed a sheet of media in a forward feed direction and a reverse feed direction.

3. The imaging apparatus of claim 2, said controller executing program instructions to feed said sheet of media in said reverse feed direction between said printing operation and said embossing operation.

4. The imaging apparatus of claim 2, said controller executing program instructions to feed said sheet of media in said reverse feed direction between said embossing operation and said cutting operation.

5. The imaging apparatus of claim 2, wherein said printing operation is performed in accordance with said printing data with said sheet of media being fed in said forward feed direction, and wherein said embossing operation is performed in accordance with said embossing data with said sheet of media being fed in said reverse feed direction.

6. The imaging apparatus of claim 5, wherein a cutting operation is performed in accordance with said cutting data with said sheet of media being fed in said forward feed direction.

7. The imaging apparatus of claim 1, further comprising a sheet turning mechanism that flips said sheet of media prior to said embossing operation to facilitate embossing on a back side of said sheet of media.

8. The imaging apparatus of claim 1, wherein said sheet of media has a front side and a back side, said embossing mechanism being positioned to emboss said back side of said sheet of media.

9. The imaging apparatus of claim 1, said embossing mechanism including a roller ball that engages said sheet of media during said embossing operation.

10. The imaging apparatus of claim 1, further comprising a reciprocating cartridge carrier having a cartridge bay for mounting at least one of a plurality of interchangeable cartridges, said plurality of interchangeable cartridges including a print cartridge containing said printing mechanism, an embossing cartridge containing said embossing mechanism, and a cutting cartridge including said cutting mechanism.

11. The imaging apparatus of claim 10, further comprising a user interface communicatively coupled to said controller, said controller executing program instructions to prompt said user to select a particular cartridge of said plurality of interchangeable cartridges to perform a next operation of said printing operation, said embossing operation, and said cutting operation.

12. The imaging apparatus of claim 1, wherein said printing data, said embossing data and said cutting data is stored in said removable memory card as encoded data.

13. The imaging apparatus of claim 1, wherein said embossing data and said cutting data is in the form of numerical control data.

14. A method for operating an imaging apparatus that processes a sheet of media having a front side and a back side, comprising:
loading a removable memory card into a memory card reader;
reading said memory card to retrieve embossing data; and
controlling an embossing mechanism to perform an embossing operation in accordance with said embossing data.

15. The method of claim 14, wherein said embossing operation is performed on said back side of said sheet of media.

16. The method of claim 15, comprising:
reading said memory card to retrieve printing data; and
printing on a front side of said sheet of media in accordance with said printing data.

17. The method of claim 15, comprising:
reading said memory card to retrieve cutting data; and
cutting said sheet of media in accordance with said cutting data.

18. A method for operating an imaging apparatus that processes a sheet of media having a front side and a back side, comprising:
loading a removable memory card into a memory card reader;
reading said memory card to retrieve printing data, embossing data and cutting data from said memory card; and
controlling a printing mechanism, an embossing mechanism and a cutting mechanism in accordance with said printing data, said embossing data, and said cutting data, respectively, to perform a printing operation, an embossing operation, and a cutting operation, respectively.

19. The method of claim 18, comprising:
moving said sheet of media in a forward feed direction during said printing operation; and
moving said sheet of media in a reverse feed direction between said printing operation and said embossing operation.

20. The method of claim 18, comprising flipping said sheet of media prior to said embossing operation to facilitate embossing on a back side of said sheet of media.

21. The method of claim 18, comprising:
moving said sheet of media in a forward feed direction during said embossing operation; and
moving said sheet of media in a reverse feed direction between said embossing operation and said cutting operation.

22. The method of claim 18, comprising:
performing said printing operation in accordance with said printing data with said sheet of media being fed in a forward feed direction;
performing said embossing operation in accordance with said embossing data with said sheet being fed in said reverse feed direction.

23. The method of claim 22, comprising:
performing said cutting operation in accordance with said cutting data with said sheet of media being fed in said forward feed direction

24. The method of claim 18, comprising prompting a user to select a particular mechanism to perform a next operation of said printing operation, said embossing operation and said cutting operation.

25. The method of claim 18, comprising encoding said print data, said embossing data and said cutting data stored in said removable memory card.
